(19) United States
(12) Patent Application Publication
(10) Pub. No.: US 2016/0179456 A1
(43) Pub. Date: Jun. 23, 2016

(54) Spontaneous Collaboration Apparatus, System and Methods thereof

(71) Applicant: SIVAPATHALINGHAM SIVAVAKEESAR, Milton Keynes (GB)

(72) Inventor: SIVAPATHALINGHAM SIVAVAKEESAR, Milton Keynes (GB)

(21) Appl. No.: 14/580,239

(22) Filed: Dec. 23, 2014

(51) Int. Cl. G06F 3/14; G06F 3/048; G06F 3/0481; G06F 17/22; G06F 3/0484; G06F 3/16; G09G 5/12

(52) U.S. Cl. CPC G06F 3/1454; G06F 3/16; G06F 3/048; G09G 5/12; G06F 17/2288; G06F 17/2205; G06F 3/0484; G06F 3/0481

(57) ABSTRACT

Embodiments of the present invention provide a control device/means and method for selectively projecting/mirroring graphical user interfaces of one or plurality of computing devices in a collaborative session. The control device configures one computing device as a master and the rest as slaves and form a collaborative network securely and in a controlled manner on demand. On receiving requests from one or plurality of computing devices that intend to project their graphical interfaces, the said control means decide in terms of which of these requesting computing devices will be allowed based on inputs from the configured master. The said control means stores one or plurality of projected screens in a control manner for one or plurality of computing devices to download and apply one or plurality of modifications before projecting the modified projected screens. The control device operates a version control for joint documents working in a controlled way.

### TECHNICAL FIELD

The present invention relates to system, apparatus, arrangement and method for enabling spontaneously collaboration among like-minded users in a controlled manner especially after forming a collaborating communication and computing network on demand. Although the intended collaboration pertains to a given physical location, it can be extended to include remote participants as well.

### BACKGROUND

Modern learning environment (e.g., classrooms, conferences, workshops and the like) and collective-decision making sessions (e.g., brain-storming sessions, planning) in both corporate and government settings have the following characteristics in common:
each participant normally takes part with a reasonably powerful or high-end computing device; and/or,
More than one speaker or presenter that would like to control the flow of speech or presentation he/she makes using his/her computing device.

It can be particularly challenging to engage in an interactive learning or collective decision making process while letting a participant quickly present his/her ideas in a controlled manner using an external visual display apparatus (e.g., multimedia projector, Television or similar monitor device) so that every other participant is able to follow the flow of the presentation—it is cumbersome to make this arrangement scales well with a number of participants. Given that the computing devices (e.g., smart-phone, tablet, notebook, e-readers, laptops) used by a participant have relatively small form-factor, it is difficult for the whole audience or other participants to follow in a collaborative session unless an external visual display apparatus is used whenever a participant presents his/her ideas.

In addition to these generic limitations in modern learning or collective decision-making environments, it is also quite challenging to selectively protect the content of any presentation material (that can be in the form of drawings, derivation of a solution to a given scientific, mathematical or any modern day problem, sketches, word/pdf document, images and any other material used by a computing device) belonging to each presenter or participant during or after a presentation. This selective protections involves letting a presenter or an owner dynamically exercise minute control over (in terms of) who can download a part or full copy of the presentation material that can be read-only (i.e., viewing only) or read and write enabled (i.e., modifiable). In addition, it is currently a challenge for one participant in a collaborative session to take the material used by a current presenter, make any modification and project the modified material on an external visual display apparatus using his/her computing device in a timely manner without having to carry out these operations manually.

Because of globalisation, in certain cases, participants of a meeting or conference, workshop may not know each other in priory. It is still a challenge for participants to introduce each other without having to physically move around. In certain cases, it is difficult to engage with a presenter during or after a presentation. While allowing any other participant to follow up with a presenter, it is again another challenge for a presenter to protect him/her from spams—this means there has to be a mechanism for each participant to exercise a minute control over who can see each type of his/her contact information.

Also, in certain interactive meetings, it is a challenge for a presenter, chair, teacher, manager or person in a similar capacity to decide in terms of who can be the next speaker or who can ask question in an orderly and fair manner. In case a chair or a person who hosts or is in charge of a collective session does not know a person in priory that wants to present next or ask a question, it is currently a challenge for a former to know the latter in terms of identity (e.g., name, profession, company attached and the like) at least when the latter expresses his/her intention. It is also a challenge to a person chairing a session (e.g., teacher, chairman, chair-person, manager) to decide dynamically in terms of who can be the next presenter/speaker and/or how much time each presenter or speaker can be allocated and indicate clearly to all participants while setting a reminder alarm especially to a current speaker or presenter.

Under certain circumstances, in case participants belong to competing or different businesses or organisations, a meeting cannot make use of existing computer or communication networks. In this case, it is a challenge to compose a secure network on demand using computing devices used by intended participants just for the purpose of joint collaboration or learning without making use of existing networks.

It would be desirable to provide a technique by which a person who is in charge of an interactive session could dynamically allow any participant of that session in a very controlled manner to present using a computing device belonging to the latter while projecting the presentation on to an external common visual display device for others to see and any subsequent presenter to take the copy of one or plurality of earlier presentations, make modifications on to them and present the modified material upon a permission is granted. The present invention tries to solve all these problems holistically.

### SUMMARY OF INVENTION

An electronic device of first type forming a collective learning or decision-making arrangement together with one or plurality of computing devices supporting a communication interface of first type and an external visual display apparatus supporting a communication interface of second type is provided. The said electronic device of first type comprises the said communication interface of first type for receiving multimedia content from one or plurality of computing devices, the said communication interface of second type for sending multimedia content to the said external visual display apparatus, internal storage/memory/database to store the received multimedia; and control means. The said electronic device of first type enables one or plurality of the said computing device to make a request to the control means for the purpose of projecting/mirroring the instantaneous computer screen(s) and the said control means dynamically choosing one or plurality of the said computing devices that have made the said requests based on one or plurality of selection criteria.

The said control means composes a first network in a controlled manner and securely between the said electronic device of first type and one or plurality of computing devices on the said communication interface of first type before any computing device can project its instantaneous screen on to the said external visual display apparatus. The said control means accepts the said requests for the purpose of projecting/mirroring the instantaneous computer screen from one or plurality of computing devices only when the said first network is composed of.

Preferably the said control means helping a user configuring one computing device as a master and other computing devices as slaves. The said master preferably imposes control in terms of which of said slaves that can join the said first network. It is preferred that the said master is able to remove one or plurality of slaves from the said first network after having connected.

It is preferred that the said electronic device of first type forming a collective learning or decision-making arrangement characterised in that each computing device having a built in visual display device (i.e., screen), wherein the said control means allows the projection/mirroring of one or plurality of chosen computing device screens on to screens belonging to one or plurality of other computing devices connected to the said first network in a controlled way. Control input for this purpose is received by the said control means from a user using a chosen computing device, a person in charge of a cooperative session (i.e., the one using a master) and one or plurality of other participants.

Preferably the said electronic device of first type forming a collective learning or decision-making arrangement characterised in that each computing device having a built in visual display device (i.e., screen), wherein the said control means allows the projection/mirroring of a chosen computing device screen on to the said external visual display apparatus.

It is preferred that the said control means enables the said electronic device of first type to store a copy of any screen projected on to the said external display apparatus selectively and enabling one or plurality of computing devices to download the said copy of the projected screen in a controlled manner. The said control means preferably enables one or plurality of computing devices to get a stored copy of a projected screen in a controlled and timely manner for making one or plurality of further modifications before projecting a modified version on to the said external visual display apparatus. The said control means further imposes limitation in terms of which computing device that can download a copy of a projected screen stored in the said electronic device of first type.

It is preferred that the said control means configures the said electronic device of first type to operate an access point (AP) for the said first network with a network identifier and enables one or plurality of computing devices to join the said first network by associating/connecting with/to the said access point in a controlled manner. The control input for this purpose is received from a person who is in charge of a cooperative session.

The said control means dynamically chooses one of the said computing devices that have made the said requests based on one or plurality of selection criteria, wherein one or plurality of selection criteria is set preferably by the said master. After choosing, the said control means sets in terms of how long the chosen computing device can project based preferably on inputs from the said master.

Preferably the said control means gets the said electronic device of first type to stream/receive audio input from the chosen computing device and to play-back/output in real-time in a controlled way.

The said electronic device of first type preferably enables a first computing device to exercise minute control over which other second computing device that can view, read or modify a classified material belonging to the said first computing device. It is also preferred that the said electronic device of first type stores a master copy of a computing document belonging to a first computing device and operates a version control means characterised in that a second computing device view, read or modify the said master copy in a controlled way.

### DESCRIPTION OF THE DRAWINGS

Non-limited and non-exhaustive embodiments are described with reference to the following figures, wherein like reference numerals refer to like parts throughout the various views unless otherwise specified. For a better understanding of the present invention, reference will be made to the following detailed description of the invention, which is to be read in association with the accompanying drawings, wherein:

FIG. 1 is an exemplary illustration of a complete framework forming a collaborative/collective learning or decision-making arrangement according to one embodiment of the present invention.

FIG. 2 exemplarily illustrates the high-level block components of an electronic device of first type according to one embodiment of the present invention.

FIG. 3 exemplarily illustrates the dynamic composition of collaborative/collective learning or decision-making network according to one embodiment of the present invention.

FIG. 4 exemplarily illustrates the controlled active participation by a computing device according to the first embodiment of the present invention.

FIG. 5 exemplarily illustrates the controlled active participation by a computing device according to the second embodiment of the present invention.

FIG. 6-1 exemplarily illustrates the message sequence chart involved as part of controlled active participation executed unilaterally by a computing device according to one embodiment of the present invention.

FIG. 6-2 exemplarily illustrates the message sequence chart involved as part of controlled active participation executed bilaterally by a computing device according to one embodiment of the present invention.

The figures are provided for ease of explanation of the basic proposals of the present invention only; the extensions of the figures with reference to number, position, relationship and dimensions of the parts to form the preferred embodiment will be explained or will be within the skill of the art after the following proposals/findings of the present invention have been read and understood.

### DESCRIPTION OF SPECIFIC EMBODIMENTS

A system, apparatus, framework, method or arrangement for allowing the composition of a collaborative session involving interactive learning, brain-storming, collective decision or the like (termed collaborative session from here on wards) is provided. The main requirement in the proposed system, framework or arrangement is to enable at least:
i) One or more computing devices to form a network on demand for the purpose of interactively engaging;
ii) Projection of one or plurality of participant screen in a controlled way on to a common wide screen (i.e., external visual display apparatus) for other participants to follow;

The motivation of such a collaborative session is to enable orderly active participation by a participant—by active participation the present invention means speaking up, making a presentation or raising a question by a participant or taking control of a collaborative session and the like. In order to ensure orderly and secure participation in such a collaborative session, a hierarchical network (e.g., master-slave) is to be composed of before any active interaction or collaboration can take place where certain computing devices take an authoritative (i.e., master) role whereas others operate in the capacity of slaves depending preferably on who uses a given computing device.

In a collaborative session participants can make multimedia presentations (e.g., using slides), ask questions or show videos, drawings or working methods related to a specific topic or puzzle or a scientific research problem in a specific order agreed statically in priory or dynamically on demand by a person who is in charge of a collective session. A person who is in charge of a collective session can be a teacher in a class-room, chairman/chair-person in a conference/workshop, and manager/leader in corporate/government/military settings. To refer to such a person in charge of a collective session, this patent uses a term chair-person in the rest of the document.

In such a collaborative session, whenever a participant (e.g., presenter) makes a presentation, other participants (e.g., audience) should be able to follow—this can be ensured if a presenter makes use of his/her computing device while mirroring the screen of a presenter's computing device on an external visual display apparatus and/or one or plurality of computing devices used by other participants (e.g., audience).

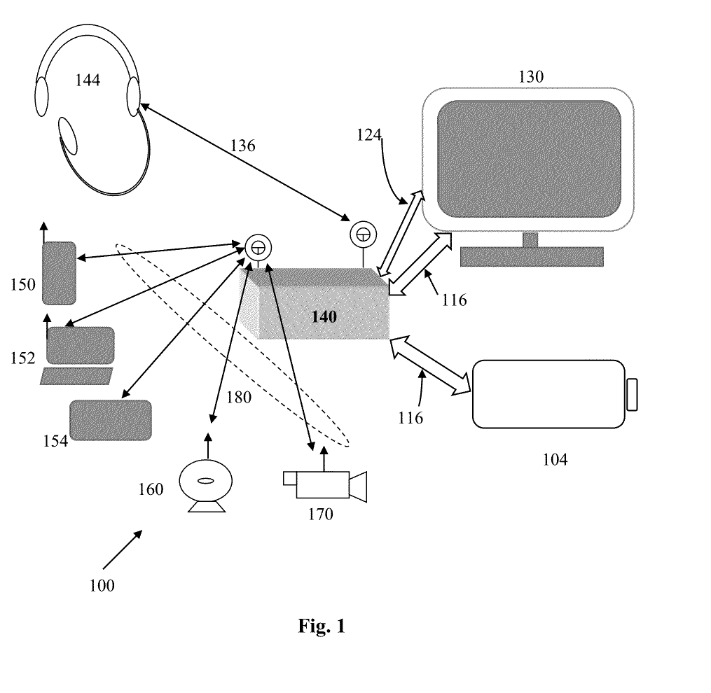

FIG. 1 is an exemplary illustration of a complete framework, system or arrangement that helps a chair-person exercise control over the order in which other participants actively take part (e.g., making presentations or asking questions) in a collaborative session. This framework, system or arrangement mainly consists of one or many computing devices 150/152/154, an electronic device of first type 140 and/or an external visual display apparatus 104/130.

According to one embodiment of the present invention, the chair-person controls in terms of who can project the multimedia content of a computing device 150/152/154 or any media capturing device such as a security-camera/web-cam 160/170 on to an external display apparatus 104/130 using the electronic device of first type 140.

This collaborative session can preferably be on-site meaning that all the participants are physically located in a given geographical location—i.e., physical class-room, conference centre, meeting room and the like. On the other hand, such an on-site collaboration session can also include one or plurality of remote participants that can be connected to a given on-site collaboration session via Internet, Local Area Networks or cellular networks or the like.

This patent uses the term computing device to refer to such devices as mobile phones, smart phones, personal digital assistants (PDAs) or portable mobile devices such as mobile tablets, electronic readers, notebooks, media players, laptops, personal computer (PC) and similar devices that are capable of storing or reproducing multimedia. Computing devices are shown exemplarily by 150, 152 and 154 to reflect the fact that there may exist a wide varieties of devices that differ in terms of form-factor, processing power, capabilities and the like. The current invention further uses the term external display device/apparatus to collectively refer to any television-set/monitor-apparatus 130, a projector 104 or a similar device.

The skilled person know the overall operation of a computing device and the necessary components thereof. Therefore these are not described herein in any more detail. It is sufficient to note that a computing device typically comprises means for processing data and/or controlling the operation thereof (e.g. a central processor unit), means for storing data and means for receiving and transmitting radio signals. The computing device 150/152/154 is shown to comprise user interface means comprising a graphical user interface in the form of a display/screen and input means in the form of control buttons. The display/screen provides the graphical user interface of a computing device. It shall be appreciated that the computing device may be provided with further or alternative user interface means, such as voice recognition means, voice output means, touch screen means and so on.

To take part in a collaborative session, each computing device 150/152/154 or any media capturing device 160/170 has to support a communication interface of first type 180. Before any active collaboration, computing devices 150/152/154 need to form a network (termed first network) on demand together with an electronic device of first type on the communication interface of first type 180.

According to one embodiment, in order to facilitate the composition of first network, the electronic device of first type 140 operates a router for one or plurality of computing devices 150/152/154 or any media capturing device 160/170 to connect to it via a communication interface of first type 180—in this case, the communication interface of first type can preferably be any wired based e.g., Ethernet. According to another preferred embodiment, the electronic device of first type 140 operates a wireless Access Point (AP) on the communication interface of first type 180. One or plurality of computing devices 150/152/154 or any media capturing device 160/170 that wants to take part in a collaborative session can associate with this AP in a normal way to form a first network.

According to the preferred embodiment, the communication interface of first type 180 is implemented using any short-range radio technology such as WiFi and WiFi-direct, Bluetooth, ZigBee, WiMedia UWB, Infra Red (IR), Wireless USB, Wireless HD, Wireless HDMI standard or the main air interface of existing and/or future infra-structure-based cellular/wireless technologies such as GPRS, 3G, LTE/LTE-A, WiMAX, WLAN and the like.

The AP may employ one or plurality of access restriction means to ensure that only the allowed computing devices 150/152/154 or media capturing devices 160/170 can connect to the first network. In case the AP is implemented based on WiFi (i.e., any flavour of IEEE 802.11 standard), one access restriction means can be implemented and executed using Wi-Fi Protected Access (WPA) or WEP (Wired Equivalent Privacy) or any equivalent protocol. According to the preferred embodiment of the present invention, a chair-person uses a computing device that is configured to operate in the capacity of a master to take part in a collaborative session—other participants use computing devices that are configured as slaves. The chair-person can have control over choosing and configuring an appropriate network identifier for the first network formed on demand—this can be a Service Set Identifier (SSID). Also, a chair-person can employ any preferred access restriction means, protocol or mechanism and/or set any preferred access restriction parameter at its discretion.

The first network formed between one or plurality of computing devices 150/152/154 and the electronic device of first type 140 needs to have at least one master node that will be used by a chair-person of a collaborative session for the purpose of exercising control in terms of at least:
Computing devices 150/152/154 or media capturing devices 160/170 that can be connected to the first network;
Which Computing devices 150/152/154 or media capturing devices 160/170 that are allowed to project its screen at a given time instance;

Whenever a first network is formed, the electronic device of first type 140 and an external visual display apparatus 104/130 will preferably form a second network using the communication interface of second type 116. According to the preferred embodiment, the communication interface of second type 116 can be implemented based on HDMI/DVI, SCART, IEEE 1394 (i.e., Firewire/iLink/Lynx), RCA-connectors-based Composite/component video, Display Port, Serial Digital Interface, S-Video, VGA and its extensions, or the like. The second network can be formed before or after the first network is formed—but this second network can be activated whenever the electronic device of first type 140 is ready to project any multimedia content on to an external visual display apparatus 104/130.

Once the physical network (i.e., first network) is formed by associating each computing device 150/152/154 with the electronic device of first type 140, each participant of a collaboration session can sign in using the collaboration tool that can be implemented in the form of a software application. This collaboration tool (termed here afterwards as a collaboration client) has to be installed on every computing device 150/152/154 before joining any first network. This can be in the form of a native application developed for a specific operating system (Android, iOS, MS Windows or the like) or a widget or a web application. After signing in a user can create an online business card or a profile identifying a particular user's name, company attached, expertise, and any other demographic or similar details. Alternatively, with a provision of Internet by the electronic device of first type 140, users can make use of existing Social Networking profiles (e.g., Facebook, LinkedIn and the like) or online business cards for this purpose. According to this arrangement any signed in participant to a given collaboration session can view the details of every other signed-in participant associated with the same collaboration session.

All users taking part in the collaborative session needs to login with user-specific credentials. Assignment of these user-specific unique credentials take place in priory and is not within the scope. A person skilled in the art can easily understand how it can be accomplished.

A collaboration client can enable a user/owner to exercise minute privacy control over which part of an online business card or social networking profile viewable by another participant of a collaborative session.

A collaboration client can be appropriately configured to operate a computing device 150/152/154 in the capacity of a master or a slave. Alternatively a master or slave device is implemented using purely hardware or software means or a combination of both.

One or the whole aspects of the collaboration system as shown by 100 can be implemented purely using software or hardware means or combinations thereof. Typical case is where the electronic device of first type 140 is hardware oriented while each computing device 150/152/154 runs a purpose-built software called collaboration client (e.g., Android, iOS or MS Windows Applications). The purpose-built software can be further configured to operate in the capacity of a master or slave at user's discretion. Normally there will be only one master in a session and one or plurality of slave devices being controlled by master for the purpose of projecting the screen in a controlled manner.

According to the first embodiment of the present invention, a signed-in participant X of a collaborative session makes a request to a chair-person for the purpose of making a presentation or asking question or simply projecting his/her computer screen on to the external visual display apparatus 104/130 or other participants' computing devices 150/152/154. This can be achieved with a simple pressing of a button appearing on a computing device 150/152/154 used by the participant X. When the participant X makes such a request, a chair-person can view in terms of who has made such a request using his/her master device. If a chair-person approves such a request again with a press of a button appearing in the computing device 150/152/154 used by a chair-person, the participant X can make a presentation or ask a question or simply project his/her computer screen on to the external visual display apparatus 104/130 or other participants' computing devices 150/152/154. This means projection or mirroring of a screen pertaining to one computing device 150/152/154 on to an external display apparatus 104/130 or other computing devices is achieved in a very controlled manner under the supervision of a chair-person.

This request-approval process can be achieved using hardware buttons, software buttons, gestures or voice commands or similar means or a combination of these.

In order to achieve control screen-projection/mirroring, the electronic device of first type takes control inputs from a master device and decides in terms of which computing device 150/152/154 or media capturing device 160/170 it has to get the multimedia signal from for the purpose of projecting or screen mirroring on to an external display apparatus 104/130 or other signed in computing devices connected to the first network.

A chair-person can similarly exercise control over the electronic device of first type 140 to remove one or plurality of computing devices 150/152/154 connected to a first network.

According to the second embodiment of the present invention, the electronic device of first type 140 stores a copy of every instantaneous screen projection made with appropriate identifiers at the discretion of a chair-person or owner of a projected screen. This can enable a participant to subsequently take a copy of an already made projection, makes one or plurality of modification before projecting a modified screen projected earlier. This can be helpful in a class room or brain-storming session for participants to draw sketches on top of existing sketches. The owner of an earlier projected screen or a master of a collaborative session can exercise control over who can view or take a read-only or read-and-write enabled copy of an already projected screen stored in the electronic device of first type 140.

According to the third embodiment of the present invention, the electronic device of first type 140 can be used for the purpose of, for instance, joint document editing/working and hence operates a version control means for the purpose of preferably embedding one or plurality of revision marks wherever necessary. It stores master copy of a classified material (e.g., document, slide, drawing, image and the like) and enables an owner of that classified material or a master of a session to exercise minute control over who else can view or get a read-only or read-and-write enabled copy of that classified material. This can be achieved both proactively and reactively. In the proactive approach, an owner or master assigns or sets privileges to every other participant in terms of who else can view or get a read-only or read-and-write enabled copy of the classified material. On the other hand, in the reactive approach, a participant makes a request to view or get a read-only or read-and-write enabled copy of a classified material and an owner/master selectively accepts/rejects each request.

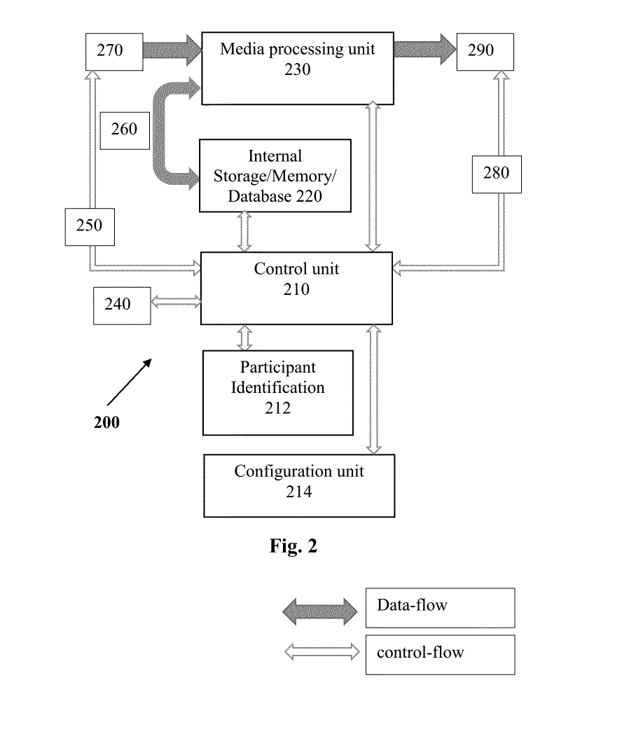

FIG. 2 exemplarily illustrates the important internal components of the electronic device of first type 140 according to one or more embodiments of the present invention. The electronic device of first type 140 can be implemented as a System on chip (SoC) or realised using pure hardware or software or combination of any of these.

In order to enable controlled projection of a user device 150/152/154/160/170 on to an external visual display apparatus 104/130 or one or plurality of other computing devices 150/152/154, the electronic device of first type 140 has a control unit 210 that receives input from a master device via 240 in order to:
Limit computing devices connecting to a first network;
Deciding in terms of which device can project or perform screen mirroring;
Remove a computing device 150/152/154 from a given first network;

The configuration unit 214 of the electronic device of first type is responsible for composing a first network associated with every collaborative session by making sure that the electronic device operates a network with appropriate SSID and access restriction parameters based preferably on one or plurality of inputs from a master. The first network is initially formed between a computing device 150/152/154 that is configured as a master and the electronic device of first type 140. Subsequently, the configuration unit 214 will enable one or plurality of computing devices 150/152/154 that are preferably configured as slaves to join the first network formed on demand based on input from the master through 210 in a controlled way.

According to one embodiment of the present invention, the electronic device of first type 140 operates a router (preferably an ADSL router) for the first network to which master and slave can maintain a physical connection using the communication interface of first type 180.

Each participant is preferably given user-specific login credentials to connect to the first network. A master/chair-person can preferably have some control in deciding this. This will ensure removing or blocking a certain participant from connecting to a collaboration network before or during a collaborative session. According to the preferred embodiment of the present invention, the electronic device of first type 140 operates a wireless Access Point (AP) preferably with an SSID and access restriction means settable by a master. This will make sure that a first network is composed of while making use of no existing networks, cabling and the like.

The electronic device of first type 140 can preferably provide Internet connection to every computing device 150/152/154 connected to a given first network in a controlled manner based on input from a master. The master of a collaborative session can decide in terms of which of the connected device 150/152/154/160/170 connected to the first network can get Internet. This can be achieved preferable using the configuration unit 214 and for this purpose the configuration unit 214 has a TCP/IP router, Dynamic Host Configuration Protocol (DHCP) and similar functionalities.

The electronic device of first type 140 can connect to an external Infrastructure network (e.g., cellular, LAN/WAN) and provide selective Internet to computing devices 150/152/154 connected to the first network in a controlled manner. This is possible with Wi-Fi Direct where devices, formally known as P2PDevices, communicate by establishing P2P Groups, which are functionally equivalent to traditional Wi-Fi infrastructure networks. The device implementing AP-like functionality in the P2P Group is referred to as the P2P Group Owner (P2P GO), and devices acting as clients are known as P2P Clients. The electronic device of first type 140 operates in the capacity of a P2P Group Owner (P2P GO) accessing the Internet through a legacy infrastructure based network (e.g., cellular, LAN/WAN) while at the same time establishing a P2P Group for the first network. Alternatively, computing devices 150/152/154 maintains intermittent connection with another AP providing Internet if required.

The electronic device of first type 140 has the ability to identify each signed in participant using the participant identification unit 212. With an input from a master at 240, a control unit 210 will exercise control in terms of where a multimedia signal is received from at 270—i.e., through appropriate control signalling 250 the control unit 210 will choose one or plurality of computing devices 150/152/154 to project instantaneous graphical user interfaces on to the external visual display apparatus 104/130 or one or plurality of other (i.e., non-chosen) computing devices 150/152/154 based on input from master. The external visual display apparatus 104/130 or one or plurality of other (i.e., non-chosen) computing devices 150/152/154 are collectively referred to as a sink device. Through appropriate control signalling 280, the control unit 210 makes sure that chosen screens are projected/mirrored on chosen sink devices properly.

Depending on the type of multimedia signal received from one or plurality of chosen computing devices and the capabilities of the sink device where screen is to be mirrored or projected, the media processing unit 230 of the electronic device of first type 140 can preferably subject the received multimedia signal at 270 to one or plurality of multimedia processing operations such as transizing or video scaling, transcoding, transrating, digital to analog, audio synchronisation, digital rights management (DRM) or conditional access (CA), error concealment technique using either spatial or temporal interpolation, 2D to 3D conversion or vice-versa.

In case of a chosen computing device owner vocally presents his/her slides, the media processing unit 230 can preferably stream the voice/audio of a presenter captured through a microphone built in a computing device 150/152/154 used by a current presenter and play-back in real-time through:
The speaker arrangement of one or plurality of computing devices 150/152/154 belonging to one o plurality of signed-in participants other than the current presenter;
Head-phones/headsets 144 used by one o plurality of signed-in participants other than the current presenter; or,
Speaker arrangement the electronic device of first type 140 is built-in with or
Any external speaker arrangement connected to the electronic device of first type 140.

This play-back of a presenter is carried out in a control manner. For this purpose, the control unit 210 gets control input from a master or a current presenter in terms of how the audio associated with a current presenter has to be played back. If playing back in head-phones/headsets 144 is preferred, the control unit gets further input in terms of who can listen to—i.e., a master or a current presenter can select in terms of who else can listen to the audio associated with the current presentation in one or plurality of head-phones/headsets 144. For this purpose, one or plurality of head-phones/headsets 144 can stream audio from the media processing unit 230 via a communication interface of first type 180 or a communication interface of third type 136. The communication interface of third type can be again a short-range wireless radio technology such as IEEE 802.11, Bluetooth, Zigbee, DECT and the like.

Alternatively, the audio associated with a current presenter is made available selectively on a plurality of computing devices 150/152/154 belonging to participants other than a current presenter by the electronic device of first type 140 via the communication interface of first type 180. Headphones/headsets 144 can get and playback the audio of a current presenter from a computing device 150/152/154 attached—this can be via a stereo output jack of an associated computing device 150/152/154 or wirelessly using any short-range radio technology.

Before sending a multimedia signal associated with screen mirroring to the electronic device of first type 140, a chosen computing device 150/152/154 or media capturing device 160/170 can apply one or plurality of multimedia compression technique (e.g., MPEG-4) to conserve bandwidth on the communication interface of first type 180.

In a collaborative session, there can be a need for a one or plurality of participants to collectively work on a joint problem—this can be a mathematical problem, puzzle, and corporate/government/military planning. For instance a current user-A is projecting a circle and user-B wants to draw a square on top of the circle. Under this circumstance, the electronic device of first type stores the snap-shot of a screen projected by user-A's computing device and lets user-B download this snap-shot in a controlled and timely manner and add a square on top of it—for this purpose editable copy of a projected screen is stored in 140. Under such circumstances, there is a need for a second participant to make one or plurality of modifications to a sketch, drawing, solution derivation, mathematical equation, joint document and the like used by a previous first participant. For this purpose, the electronic device of first type 140 stores in a controlled manner (preferably an editable version of) every screen projections in its internal storage, memory (preferably be non-volatile) or database 212 based on inputs from a master or an owner of a screen projected/mirrored. The electronic device of first type 140 stores either the instantaneous screen shots or the whole presentation slide/material for download by others.

This storage/database is created and organised systematically so that any past projected/mirrored screens can be retrieved by any allowed participant in a controlled manner. An owner ID, time instance at which projected or similar unique identifier can be used as an index to store a given projected/mirrored screen in an internal database 220. This means the database 220 can be browsed by a participant as long as a permission is granted to view, download and/or modify. Alternatively, the whole presentation can be saved with a proper identification.

Whenever a signed-in participant to a given collaborative session wants to download a past projected/mirrored screen stored in the internal storage 220 of the electronic device of first type 140, a corresponding request is made the control unit 210. The control unit will then check with a master or owner of a projected screen with an identity of the requester to see whether a permission is granted. The control unit 210 will then act upon the answer received—i.e., if a permission is granted a download is allowed.

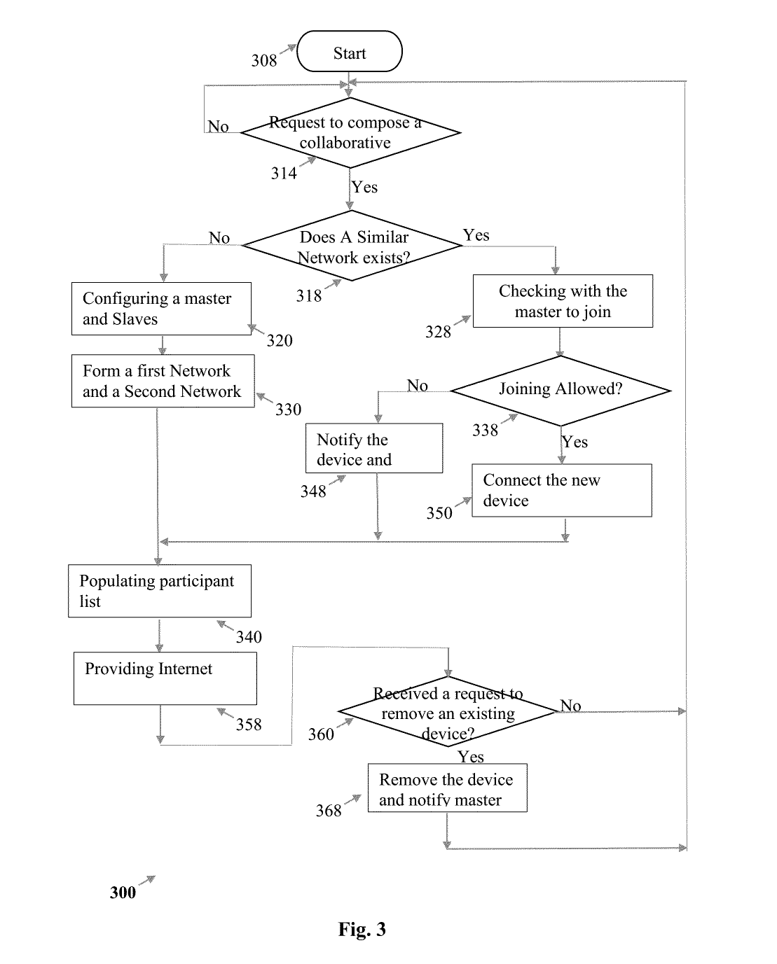

FIG. 3 exemplarily illustrates the steps involved in forming or making associated underlying networks ready for any intended collaborative session according to one or more embodiments of the present invention. This is analysed from the perspective of the electronic device of first type 140. At the decision-making step 314, it is checked by the electronic device of first type 140 whether any computing device 150/152/154 which is configured as a master makes a request to compose a first network on demand for any collaborative session or any slave device wants to join an already established first network. Normally such a request to compose a first network arise from a chair-person of any collaborative session, whereas a request to join an existing first network normally is triggered by a participant other than a chair-person. If no such a request is received, the control element 210 of the electronic device of first type 140 will still wait for any such request in 314. If, on the other hand, such a request is received at step 314, it will be checked in the decision-making step 318 whether the electronic device of first type 140 is already involved in any active collaborative session—if it is the case, the requester will be notified.

If, on the other hand, it is decided that the electronic device of first type 140 is not part of any collaborative session or any first network, a chairman will be prompted to configure one computing device 150/152/154 as a master and others as slaves in the processing step 320. Then optionally a chairman will be prompted to get the electronic device of first type 140 operate a first network preferably with a given SSID. In addition, a chairman will be prompted to choose one or more access restriction means for the purpose of limiting other slaves joining this first network for preferably security reasons. The chairman will be then prompted to associate the master with the first network at the processing step 330. At this step, the chair-person will preferably be prompted to connect the electronic device of first type 140 and the external visual display apparatus 104/130, if required based on the input from the chair-person—this will form the second network, in case such a network is in non-existent before.

If the request at the decision-making step 314 is to join an existing collaborative session (i.e., existing first network), the electronic device of first type 140 will preferably check with the master associated at the processing step 328 whether a request to join a network by a given computing device 150/152/154 that operates in the capacity of a slave is allowed. If it is decided at the decision-making step 338 that such a join request is allowed by the master, the electronic device of first type 140 will associate a slave that has triggered a join request in the processing step 350. If, on the other hand, the master does not want a particular participant to join its collaborative session, the requester will be notified in the processing step 348.

Once the first network and second networks are formed as of step 330 or whenever a slave device has successfully joined an existing collaborative session (i.e., a first network) as of step 350, respective participants will be prompted to sign-in to a given collaborative session. This is possible with the collaboration client installed in every computing device 150/152/154 that has become part of a given first network. A master or slave can join the first network remotely via the Internet. A signed-in participant is able to see other signed-in participants as indicated by a processing step 340. Signed-in participants to a collaborative session can take part in online-polling, election, referendum, voting and the like. Further, a master can decide in terms of who can get Internet at an optional step 358.

A master can preferably remove an existing participant at any point in time—this can be executed through the electronic device of first type 140. This is exemplarily illustrated by steps 360 and 368 although it can happen any time after the first network is formed at step 330 or once a device has joined as indicated by step 350.

Once the first network is formed preferably by following the steps as indicated by 300, it will preferably take a star-topology.

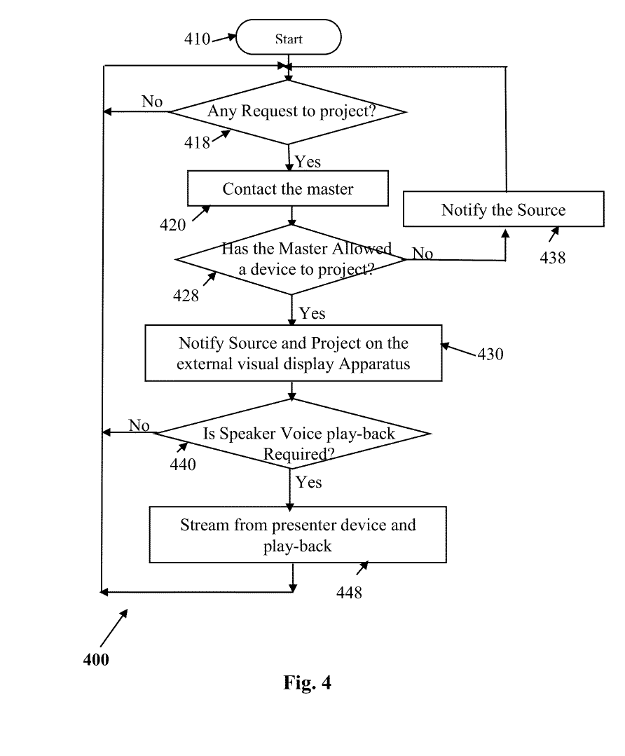

FIG. 4 exemplarily illustrates the steps involved for any active participation to take place in a collaborative session once it is formed or setup as explained in connection with FIG. 3 according to the first embodiment of the present invention. This is analysed from the perspective of the electronic device of first type 140. By active participation, this patent preferably means an act by a participant to make a request for the purpose of preferably making a presentation while projecting/mirroring his/her computer screen. Asking a question or making a speech or taking in charge of a session can also form the basis of an active participation. When making a request, a participant can indicate in terms of what type of active participation is preferred using a computing device 150/152/154—for this purpose, each computing device that is configured in the capacity of a slave has hardware or software means or a combination of both built-in.

As indicated by the decision making step 418, it is checked whether any signed-in participant to a given collaborative session, to which a given electronic device of first type 140 is associated with, has made a request to have an active participation. This is achieved by a participant to prompt the chair-person. To have a scalable solution, a participant can make use of his/her computing device 150/152/154 to raise/trigger such a request. For this purpose, each computing device has hardware, software means or a combination of both built-in. According to the preferred embodiment of the present invention, the collaboration client installed in every computing device 150/152/154 enables a signed in client to raise such a request.

If such a request is received in step 418, the electronic device of first type 140 can pass that request to a master along preferably with an identity of a requester at step 420. The master/chair-person can notice this request in his/her master device preferable in the order in which it arrives. Master/chair-person can apply one or plurality of selection criteria to choose the appropriate participant that can make an active participation next. This selection criterion can preferably be based on first-in first-out (FIFO) order, last-in first-out (LIFO) order, privilege enjoyed by a requester (e.g., management hierarchy in a company, establishment or government organisation, ranking (e.g., military)), knowledge-level of a requester, appropriateness of a request to the current discussion and the like. Alternatively, a chair-person can choose one or plurality of requesters arbitrarily at its discretion.

Once the selection is made in terms of who can make the next active participation by a master/chair-person at the decision-making step 428, one or plurality of requesters will be notified of the outcome of the decision by the electronic device of first type 140. The master device used by a chair-person has hardware, software or a combination of both built-in preferably to see one or plurality of requests along with requester profiles in different orders according to the selection criteria chosen and to notify the decision with regard to the selection to the electronic device of first type 140. According to the preferred embodiment of the present invention, the collaboration client installed and configured appropriately to operate a computing device 150/152/154 in the capacity of a master can be used for this purpose.

If an active participation by one or plurality of requesters are approved by a master/chair-person, the respective requester(s) will be notified to generate and transmit multimedia signal associated with the screens to be projected/mirrored to the electronic device of first type 140 as exemplarily indicated by step 430. Selection of appropriate sink devices is decided by a requester or a master. Once it is decided in terms of where intended screens belonging to one or plurality of chosen requesters to be projected/mirrored, the electronic device of first type 140 will notify relevant sink devices and ensure the correct proj ection/mirroring preferably after subjecting the received multimedia signals to one or plurality of media processing operations.

Once chosen, the master/chair-person associated with a given collaborative session can set a timer to indicate in terms of how long one or plurality of chosen requesters can make an active participation. Remaining time available can be displayed preferably in every computing devices 150/152/154 or external visual display apparatus 104/130 involved in a given collaborative session. A chair-person has total control in terms of how quickly a chosen requester has to make the active participation and a chair-person can terminate any active participation by any chosen requester at any point in time using his/her master device preferably after giving or issuing a warning.

In case a current active participant makes a vocal presentation along with presentation slides, the electronic device of first type 140 can capture audio/voice generated by a current presenter, stream it and play back in real-time. This is achieved in a controlled manner preferably using the inputs from a master, an owner of audio and the like. These steps are indicated by steps 440 and 448.

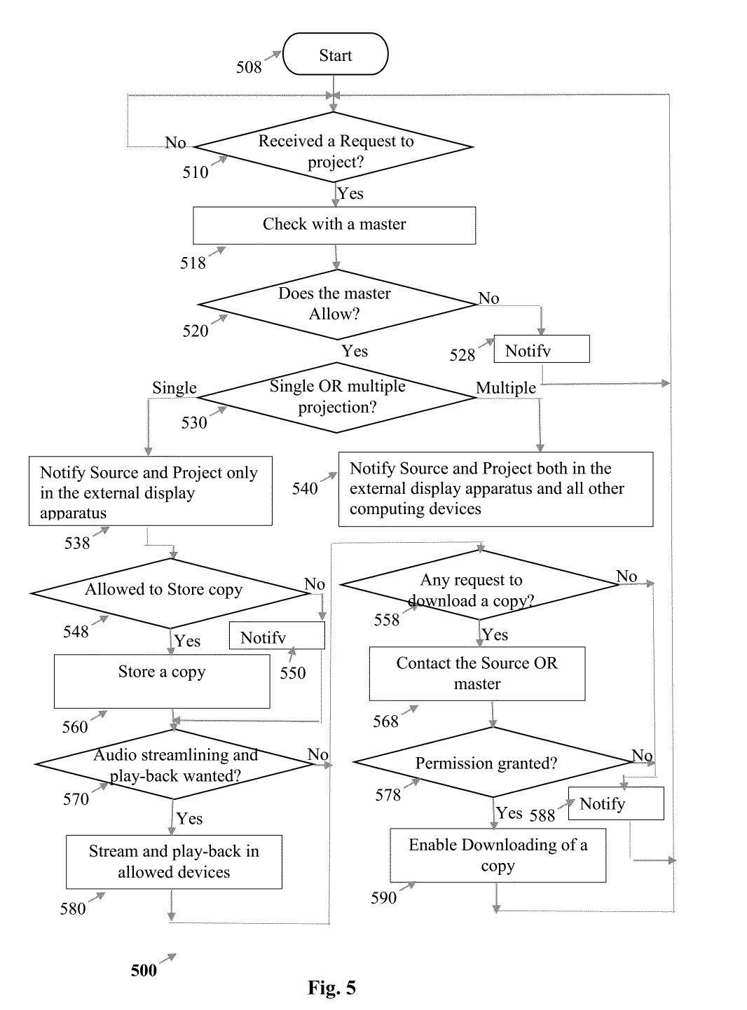

FIG. 5 exemplarily illustrates the steps involved for any active participation to take place in a collaborative session once it is formed or setup as explained in connection with FIG. 3 according to the second embodiment of the present invention. Some steps 510, 518, 520 and 528 involved as part of 500 are equivalent to those of steps 410, 418, 420 and 428 respectively.

In the decision-making step of 530, it is checked whether one or plurality of screens associated with chosen requester(s) are to be mirrored/projected on to the external visual display apparatus 104/130 or computer devices 150/152/154 used by one or plurality of participants (i.e.,) taking part in a given collaborative session or both. If only projection/mirroring is preferred on 104/130, respective sources (i.e., computing devices used by chosen requesters at step 520) are notified and one or plurality of the associated screens are projected on the external display apparatus 104/130 as indicated by step 538. Relevant input for the electronic device of first type 140 to make the necessary decision in this respect at step 530 is made by a master or presenter or one or plurality of participants.

At step 548, the electronic device of first type 140 checks whether it has to make copy of each projected screen. As mentioned this is achieved in a controlled manner and relevant instructions are given to the electronic device of first type 140 by a master or presenter or one or plurality of participants. In case storing a copy of each instantaneous screen is requested, the electronic device of first type 140 will store relevant screen-shots in its internal database 220 systematically so that any allowed signed-in participant can browse them in an orderly manner. Steps 570 and 580 are equivalent to steps 440 and 448 respectively.

At the decision-making step 558, the electronic device of first type 140 checks whether any signed-in participant has made a request to download a copy of any old projected screen stored in the internal database 220. Permission can be sought preferably on demand as indicated in step 568. The permission can be given by either a master or an owner of an earlier projected screen. If a permission is granted, any requester can download a copy of one or plurality of previously projected screens as indicated in step 590.

A download copy can be read-only or read-and-write enabled depending on how the access rights/privileges are set either by a master or an owner of the downloaded projected screen. If permission is granted, a signed-in participant who has downloaded a projected screen can make one or plurality of modification before projecting the modified version. In the proactive case, an owner or the master set privileges for one or plurality of other participants for the purpose viewing or making a read-only or read-and-write enabled copy of a given material. In the reactive case, any other participant has to request the owner or a master to view or get a read-only or read-and-write enabled copy and the owner/master subsequently accept/reject the requests.

In order to allow controlled participation or projection of a screen, permission request and grant process as explained in connection with steps 328/338/350, 428/430, 440/448, 518/520, 530, 548/560, 570/580, 558/568, 578/590 or any similar situation as applicable within the context of this present invention can happen reactively on demand—however, this can be time-consuming. Alternatively, by setting appropriate rights, privileges, priority and the like to each participant of any collaborative session in priory in a proactive manner, similar goal can be achieved by skipping these steps. Alternatively similar goal can be achieved by utilising a combination of both proactive and reactive measures.

The electronic device of first type 140 can record all multimedia signal associated with a given collaborative session in real-time and enable one or plurality of remote participants connected via the Internet to take part, listen to or watch in real-time or for future use. In this respect, the electronic device of first type 140 functions as a media server for the sake of remote participants.

The electronic device of first type 140 enables digital rights management (DRM) or conditional access (CA) for safeguarding ownership of ideas, presentation documents and the like. It further enables an owner to know in terms of who has viewed or downloaded a read-only or read-and-write enabled copy of a classified material. Also, High-bandwidth Digital Content Protection (HDCP) protocol for copy protection and the encryption/security technique to be employed can be agreed at the time of initial first network formation.

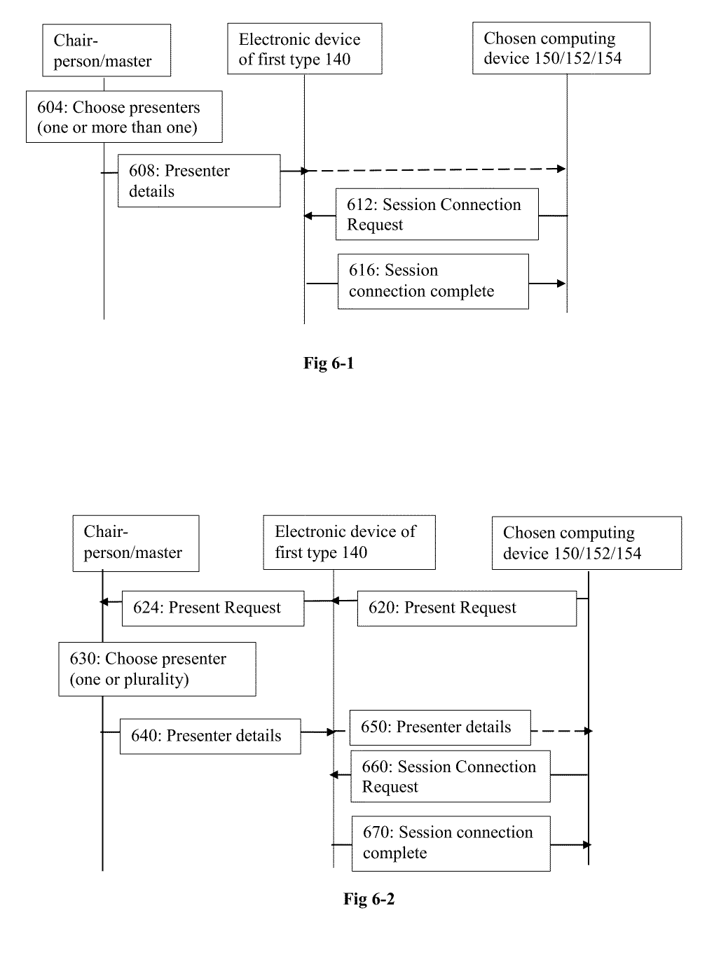

FIG. 6-1 exemplarily illustrates the message sequence chart involved as part of controlled active participation executed unilaterally by a computing device according to one embodiment of the present invention. Once connected to a first network and a participant signed-in to a given collaborative session using a computing device 150/152/154, a chair-person chooses unilaterally the order in which any participant or any media capturing device 160/170 is allowed to project its screen or multimedia signal. Accordingly at step 604, the master/chair-person chooses one or plurality of participants for this purpose. In step 608, the chosen participant details are passed on to the electronic device of first type 140. In step 612, the electronic device of first type 140 makes a request to one or plurality of chosen participants to get ready and project the screens. One or plurality of chosen participants can respond in step 616—in case they are ready, they can project.

FIG. 6-2 exemplarily illustrates the message sequence chart involved as part of controlled active participation agreed bilaterally between any participant and a chair-person according to one embodiment of the present invention. Once connected to a first network and a participant signed-in to a given collaborative session using a computing device 150/152/154, one or plurality of participants can make a request to the master/chair-person for the purpose of actively participating (e.g., projecting or mirroring his/her computer screen on to a sink device) via the electronic device of first type 140—this is shown by steps 620 and 624. Whenever such a request is made, the control unit 210 handles it and pass it on to a master. When a master approves a request from a participant to project at step 630, it will notify identities associated with one or plurality of chosen participants to the electronic device of first type 140 using the step 640.

In return in step 650, the electronic device of first type 140 will get the computing device 150/152/154 used by the chosen participant to transmit the multimedia signal associated with every instantaneous screens to be projected/mirrored to the media processing unit 230, which will then connect to the right sink device to project every allowed instantaneous screen. For this purpose, one or plurality of chosen computing devices 150/152/154 used by the chosen participant(s) will make the session connection request in step 660 which will be subsequently responded by the electronic device of first type 140 either negatively or positively.

In case of a single-presenter session, when the Session Request message is received, the electronic device of first type 140 will quickly inquire whether any of the sink devices 104/130 is free and whether it is currently busy with any other device 150/152/154/160/170. If any of the sink devices 104/130 is free and 140 is not busy with any session in-progress, then the electronic device of first type 140 will first turn the sink device 104/130 on and make the necessary session related configurations. Once this is complete, the electronic device of first type 140 will accept the Session Request and respond positively.

In a multi-participant problem solving or collective-learning or collective decision-making situations, for participant-2 to make addition or modification on top of participant-1 material, the required material of participant 1 is quickly copied to participant-2 device where participant-2 can make change and present when a chairman allows. Once a modification is approved, it will be stored in (master-copy) in the electronic device of first type 140. Similar approach will be continued until join session is over.

Once connected to a first network and a participant signed-in to a given collaborative session using a computing device 150/152/154, a participant can make a request to project or mirror his/her computer screen on to a sink device. Whenever such a request is made, the control unit 210 handles it and pass it on to a master. When a master approves a request from a participant to project, the control unit 210 will get the computing device 150/152/154 used by the chosen participant to transmit the multimedia signal associated with every instantaneous screens to be projected/mirrored to the media processing unit 230, which will then connect to the right sink device to project every allowed instantaneous screen.

The electronic device of first type 140 can be implemented through software and/or hardware means. In a software-based system, the functional units described hereinabove may be implemented on a computer system (commonly, a server, personal computer or mobile computing platform) executing program instructions corresponding to the functional blocks and methods listed above. The program instructions themselves may be stored in a storage device, such as an electrical, optical or magnetic storage medium, and executed by a processor of the computer system. In a hardware-based system, the functional blocks illustrated above may be provided in dedicated functional units of processing hardware, for example, digital signal processors, application specific integrated circuits, field programmable logic arrays and the like. The processing hardware may include state machines that perform the methods described in the foregoing discussion. The principles of the present invention also find application in hybrid systems of mixed hardware and software designs.

Several embodiments of the invention are specifically illustrated and/or described herein. However, it will be appreciated that modifications and variations of the invention are covered by the above teachings and within the purview of the appended claims without departing from the spirit and intended scope of the invention.

1. An on-the-fly multi-user collaboration system comprising:
i) Control means;
ii) One or plurality of computing devices supporting a communication interface of first type;
iii) An electronic device of first type supporting the said communication interface of first type and a communication interface of second type;
iv) An external visual display apparatus supporting the said communication interface of second type;
Characterised in that one or plurality of the said computing devices projecting or mirroring instantaneous computer screen(s) in a controlled manner at a time;
Wherein one or plurality of the said computing device making a request to the control means for the purpose of projecting/mirroring the instantaneous computer screen(s) and the said control means dynamically choosing one or plurality of the said computing devices that have made the said requests based on one or plurality of selection criteria.

2. The said on-the-fly multi-user collaboration system according to claim 1, wherein the said control means composing a first network in a controlled manner and securely between the said electronic device of first type and one or plurality of computing devices on the said communication interface of first type before any computing device can project its instantaneous screen on to the said external visual display apparatus.

3. The said on-the-fly multi-user collaboration system according to claim 2, wherein the said control means accepting the said requests from one or plurality of computing devices only when the said first network is composed of.

4. The said on-the-fly multi-user collaboration system according to claim 2, wherein the said control means helping a user configuring one computing device as a master and other computing devices as slaves.

5. The said on-the-fly multi-user collaboration system according to claim 4, wherein the said master imposing control in terms of which of said slaves that can join the said first network.

6. The said on-the-fly multi-user collaboration system according to claim 5, wherein the said master being able to remove one or plurality of slaves from the said first network after having connected.

7. The said on-the-fly multi-user collaboration system according to claim 1, wherein the said control means enabling the said electronic device of first type to store a copy of any screen projected on the said external display apparatus and enabling one or plurality of computing devices to download the said copy of the projected screen in a controlled manner.

8. The said on-the-fly multi-user collaboration system according to claim 7, wherein the said control means enabling one or plurality of computing devices to get a stored copy of a projected screen in a controlled manner for making one or plurality of further modifications before projecting a modified version.

9. The said on-the-fly multi-user collaboration system according to claim 8, wherein the said control means imposing limitation in terms of which computing device that can download a copy of a projected screen stored in the said electronic device of first type.

10. The said on-the-fly multi-user collaboration system according to claim 2 characterised in that each computing device having a built in visual display device (i.e., screen), wherein the said control means allows the projection/mirroring of a chosen computing device screen on to screens belonging to one or plurality of other computing devices connected to the said first network in a controlled way.

11. The said on-the-fly multi-user collaboration system according to claim 2, wherein the said control means configuring the said electronic device of first type to operate an access point (AP) for the said first network with a network identifier and enabling one or plurality of computing devices to join the said first network by associating/connecting with/to the said access point in a controlled manner.

12. The said on-the-fly multi-user collaboration system according to claim 1 characterised in that the said control means dynamically choosing one of the said computing devices that have made the said requests based on one or plurality of selection criteria, wherein one or plurality of selection criteria is set by the said master.

13. The said on-the-fly multi-user collaboration system according to claim 1, wherein the said control means getting the said electronic device of first type to stream/receive audio input from the chosen computing device and to play-back/output in real-time in a controlled way.

14. The said on-the-fly multi-user collaboration system according to claim 1 characterised in that the said control means dynamically choosing one of the said computing devices that have made the said requests based on one or plurality of selection criteria, wherein control means assigning a time-period to the chosen computing device.

15. The said on-the-fly multi-user collaboration system according to claim 2, wherein when a first participant using a computing device connected to the said first network signs in, a second participant who has already signed in using another computing device connected to the said first network learning the information about the first participant.

16. The said on-the-fly multi-user collaboration system according to claim 2, wherein the said control means enabling one or plurality of computing devices connected to the said first network to take part in polling, election, voting, referendum and the like.

17. The said on-the-fly multi-user collaboration system according to claim 1, wherein the said electronic device of first type enables a first computing device to exercise minute control over which other second computing device that can view, read or modify a classified material belonging to the said first computing device.

18. The said on-the-fly multi-user collaboration system according to claim 1, wherein the said electronic device of first type stores a master copy of a computing document belonging to a first computing device and operates a version control means characterised in that a second computing device can view, read or modify the said master copy in a controlled way.

19. An electronic device of first type forming a collective learning or decision-making arrangement together with:
i) One or plurality of computing devices supporting a communication interface of first type;
ii) An external visual display apparatus supporting the said communication interface of second type;
The said electronic device of first type comprising:
a) the said communication interface of first type for receiving multimedia content from one or plurality of computing devices;
b) the said communication interface of second type for sending multimedia content to the said external visual display apparatus;
c) internal storage/memory/database to store the received multimedia; and,
d) control means
Wherein the said electronic device of first type enables one or plurality of the said computing device to make a request to the control means for the purpose of projecting/mirroring the instantaneous computer screen(s) and the said control means dynamically choosing one or plurality of the said computing devices that have made the said requests based on one or plurality of selection criteria.

20. A method for forming a collective learning or decision-making network that consists of:
i) One or plurality of computing devices supporting a communication interface of first type;
ii) An external visual display apparatus supporting the said communication interface of second type;
iii) An electronic device of first type supporting the said communication interface of first type and the said communication interface of second type;
The method comprising:
a) Choosing one or plurality of computing devices to project instantaneous graphical user interfaces on to the said external visual display;
b) Communication of information associated with the instantaneous graphical user interfaces from one or plurality of computing devices chosen to the said external visual display apparatus over the said communication interface of first type;
c) Generation of a multimedia signal based on information associated with instantaneous graphical user interfaces; and,
d) Displaying instantaneous graphical user interfaces on the external visual display apparatus via the said communication interface of second type based on the generated multimedia signal.
